(19) United States
(12) Patent Application Publication
(10) Pub. No.: US 2004/0258561 A1
(43) Pub. Date: Dec. 23, 2004

(54) Hazardous substance detection device

(76) Inventors: Michael T. Reimer, Boynton Beach, FL (US); John B. Molenda, Loxahatchee, FL (US)

Correspondence Address: Law Office of Leo Zucker, Suite 480, 50 Main Street, White Plains, NY, 10606-1964, US

(21) Appl. No.: 10/408,381

(22) Filed: Apr. 7, 2003

Related U.S. Application Data
(60) Provisional application No. 60/447,194, filed on Feb. 13, 2003.

(51) Int. Cl. G01N 31/22

(52) U.S. Cl. 422/56; 422/58

(57) ABSTRACT

A device for detecting the presence of hazardous substances includes a support layer and a number of reagent media disposed at corresponding locations on a front surface of the support layer. Each of the reagent media exhibits (i) a known rest color when in a non-reactive state, and (ii) a reaction color different from the rest color when the media reacts with a certain hazardous substance. The reagent media are covered by a cover layer through which portions of the media are visible, and text indicia in proximity to a given reagent media identifies the hazardous substance with which the given media reacts. The rest color of a given reagent media is matched by corresponding color indicia located on the device in proximity to the given reagent media. Thus, one or more reacting reagent media can be identified by contrast of their reaction colors with the color indicia on the device.

### CROSS REFERENCE TO RELATED APPLICATION

Under 35 U.S.C. § 119(e), this application claims the priority of U.S. Provisional Patent Application No. 60/447,194, which was filed Feb. 13, 2003.

### BACKGROUND OF THE INVENTION

1. Field of the Invention

The present invention relates generally to devices of the kind that detect harmful substances and display corresponding indications.

2. Discussion of the Known Art

The use of toxic chemicals, agents and other hazardous materials in modern products and manufacturing processes poses an ongoing threat to the health and safety of emergency response teams each time they respond to a fire or distress call. There are also security concerns that such substances may be deployed intentionally to inflict harm. Accordingly, there is a need for a reliable hazardous substance detection device that can be worn conveniently by private citizens as well as police officers, firefighters, EMS personnel, hospital workers, USAR teams, and the military. Currently, such individuals must tape a number of different indicator (reagent) strips to their clothing in an effort to detect a potentially contaminated atmosphere, surface or liquid. Such a procedure is sometimes difficult if not impossible to implement, particularly if the individual is wearing chemical protective clothing.

Emergency responders do not typically possess real-time electronic monitoring units among their ensemble of personal protective equipment. The cost of electronic monitoring units is prohibitive due to the number needed to equip all members of a typical response team. In addition, the cost to maintain such units would be prohibitive as they require calibration and other maintenance procedures to be performed on a regular basis.

With respect to firefighters, many fires produce acrid smoke and therefore tend to obscure certain odors that would otherwise indicate the presence of a hazardous substance. Also, firefighters who don respirators at the scene so as to inhale only purified air, then become unable to sense any outside odor that could signify the presence of a harmful chemical or agent. And, in fact, certain dangerous chemicals are odorless. Several of the known detection devices are summarized below.

A product sold under the name “Spilfyter” is in the form of a long rod or stick and is intended for testing of potentially hazardous liquid chemicals. The stick has several reagent strips disposed along its length, labeled “Test 1”, “Test 2”, etc. A separate color reference chart is provided showing those colors which each of the test strips would assume when activated by immersion in a corresponding target liquid. The product is not arranged to be worn on a person's clothing or uniform, and tests only for the presence of certain liquids.

U.S. Pat. No. 6,336,964 (Jan. 8, 2002) relates to an ozone indicator. The indicator includes a color change layer comprised of an ozone sensor ink, and a non-color change layer. Both of the layers are formed on a substrate, and the color change layer is arranged for exposure to the atmosphere when the indicator is in use.

U.S. Pat. No. 6,284,198 (Sep. 4, 2001) discloses a user wearable, warning sign device for detecting a polluting gas. An indicating layer is formulated to change color in response to a particular toxic gas or vapor in the atmosphere, and the layer is deposited on a substrate to define a warning symbol or word. The substrate with the indicating layer are covered by a plastics front cover having a triangular opening to expose the layer through an intermediate porous screen.

U.S. Pat. No. 5,763,158 (Jun. 9, 1998) discloses a device for testing the presence of multiple target antigens or antibodies. FIG. 3 of the patent shows a biologic-chemical badge detector having ten discrete binding sites arranged on a membrane support.

U.S. Pat. No. 5,192,500 (Mar. 9, 1993) discloses a firefighter safety badge containing a number of indicator strips that change color in the presence of toxic agents that are labeled next to each strip. The wearer enters information including his/her name, date, time and location on the label and places the label at a known location at a fire or emergency site to which the wearer has been assigned.

U.S. Pat. No. 3,681,027 (Aug. 1, 1972) shows a colorimetric indicator for detecting nitrogen dioxide. A pellet of indicator material is mounted in a plastics housing, and is exposed through a hole to the atmosphere when a pressure sensitive sealing tab is removed from over the hole. A color chart on the housing near the hole has color panels for “indicating a degree of color change obtained for a fixed time interval on exposure to known concentrations of nitrogen dioxide.” (Column 3, lines 27-29).

### SUMMARY OF THE INVENTION

According to the invention, a device for detecting the presence of hazardous substances in a user's environment, has a support layer and a number of reagent media disposed at corresponding locations on a front surface of the support layer. Each one of the reagent media exhibits (i) a known rest color when in a non-reactive state, and (ii) a reaction color different from the rest color when the media reacts with a certain hazardous substance. A cover layer is disposed over the reagent media and is formed so that each of the reagent media is visible through the cover layer. Either the support layer or the cover layer has text indicia that is visible on or through the cover layer and located so that the hazardous substance with which a given reagent media reacts, is identified by the text indicia in proximity to the given reagent media. Either the support layer or the cover layer has color indicia which is visible on or through the cover layer, and which is placed so that (i) the rest color of a given reagent media is matched by the color indicia in proximity to the given reagent media, and (ii) when one or more of the reagent media react with hazardous substances, the reacting reagent media are identified by contrast of their reaction colors with the color indicia proximate to the reagent media.

For a better understanding of the invention, reference is made to the following description taken in conjunction with the accompanying drawing and the appended claims.

### BRIEF DESCRIPTION OF THE DRAWING

In the drawing:

FIG. 1 is a front elevational view of a hazardous substance detection device according to the invention;

FIG. 2 is a view similar to FIG. 1, with composite layers of the inventive device broken away to show further details of the device;

FIG. 3 is an end elevational view of the inventive device as seen from the left side in FIG. 1, with a paper layer being pulled away from the back of the device; and

FIG. 4 is an end elevational view of the inventive device as seen from the right side in FIG. 1, with a protective film layer being pulled away from the front of the device.

### DETAILED DESCRIPTION OF THE INVENTION

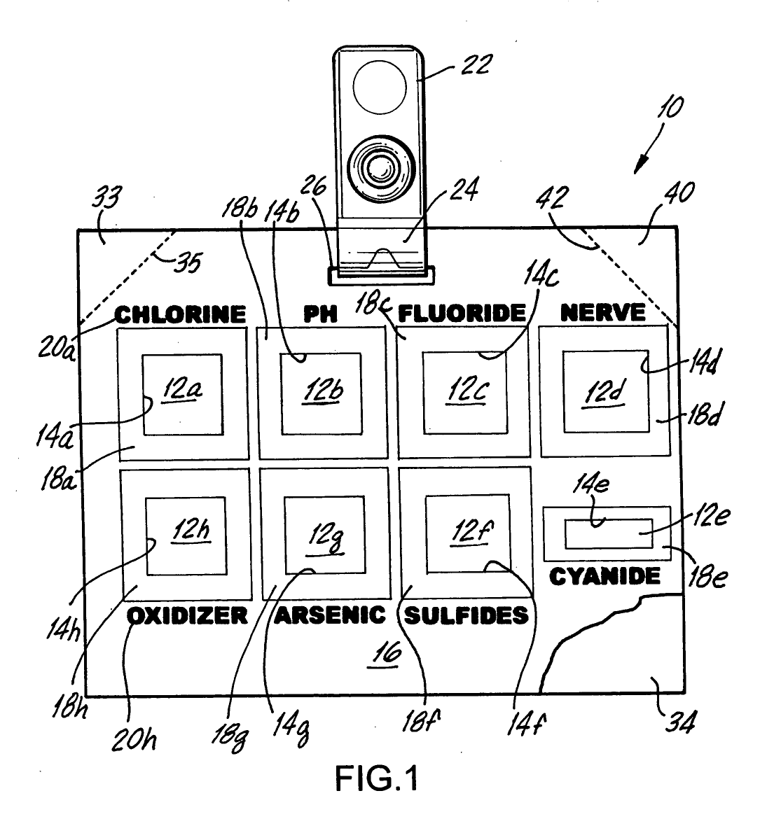

FIG. 1 is a front elevational view of a hazardous substance detection device 10, according to the invention. The device 10 has approximately the same dimensions as a typical baseball card, and embodies a number of different reagent strips or media that exhibit a change of their respective colors when they are exposed to certain classes of vapors or liquids, as detailed below. In the illustrated embodiment, eight reagent media 12a to 12h are visible through associated windows or cutouts 14a to 14h in a cover layer 16. The media 12a-12h serve to alert a user to minute levels of, for example, chlorine, abnormal pH, fluoride, nerve agents, cyanide, sulfides, arsenic and oxidizers, in liquid or aerosol form in the user's environment.

Each of the cutouts 14a-14h in the cover layer 16 has an associated border 18a-18h which frames the cutout and is of a color that matches a rest or unreacted color of the particular reagent media visible through the cutout. Text indicia 20a-20h printed next to each cutout identifies a particular hazardous substance that is targeted by the reagent media visible through the corresponding cutout. Any change of color of a given reagent media from its rest color to a different color indicative of the presence of the target substance, will therefore be readily apparent by contrast of the media's reaction color with the adjacent color border on layer 16 that frames the media. A fire or rescue team would then be alerted to obtain additional protective gear, decontaminate, or evacuate, depending on the class or classes of hazardous substances identified by the text indicia 20a-20h adjacent to the reacting reagent media.

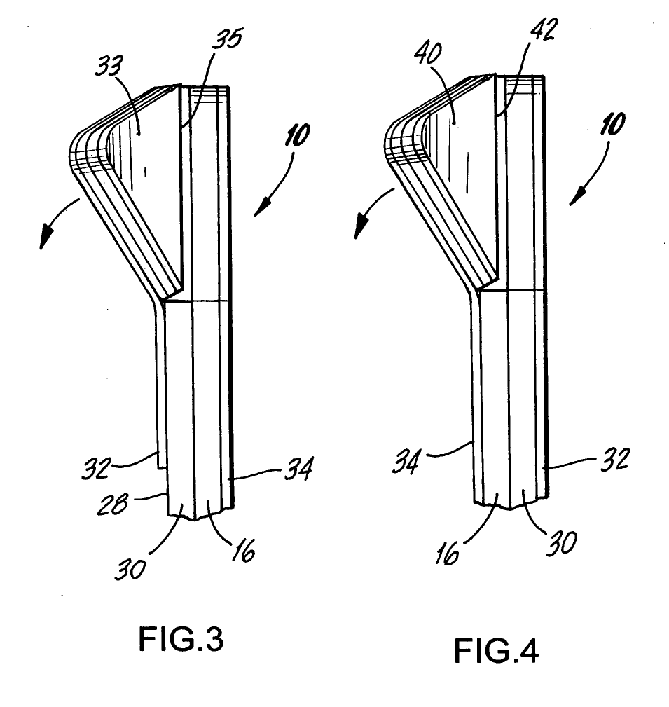

The detection device 10 may be secured to part of a person's clothing or uniform, for example, a collar or an edge of a shirt pocket, by an attached spring biased “squeeze” clip 22. The clip 22 is fixed to the device 10 by a strap 24 that loops through a slot 26 formed near an edge of the device, as seen in FIG. 1. The detection device 10 may also be fastened to clothing or on a uniform using a contact adhesive 28 provided on a rear major surface of a substrate or support layer 30 of the device, as shown in FIG. 3. A paper layer 32 is preferably adhered against the contact adhesive 28 to prevent the adhesive from coming into direct contact with outside surfaces until the paper layer 32 is removed.

To facilitate removal of the paper layer 32, a corner ear 33 is defined at, e.g., the upper left corner of the device as seen in FIGS. 1 and 3. The ear 33 is bounded by a dotted line 35 that represents an edge of a cut that extends through (a) a protective, clear film layer 34 that is initially applied over the top surface of the cover layer 16 to keep the reagent media fresh, (b) the cover layer 16, and (c) the support layer 30. Thus, the paper layer 32 can be peeled away easily from the contact adhesive 28 on the support layer 30 by grasping the ear 33 and pulling it backward as shown by the arrow in FIG. 3, until the paper layer 32 is fully separated from the back of the device 10.

The film layer 34 is initially adhered on the cover layer 16 by way of, e.g., a low tack adhesive so that when withdrawn to activate the device 10, the layer 34 will not tend to remove any inked or reagent media surfaces against which it was initially disposed. To facilitate removal of the film layer 34, a corner ear 40 is defined at, e.g., the upper right corner of the device as seen in FIGS. 1 and 4. The ear 40 is bounded by a dotted line 42 that represents an edge of a cut that extends through (a) the rear paper layer 32, (b) the support layer 30, and (c) the cover layer 16. The film layer 34 may be easily peeled away from the front surface of the cover layer 16 and each of the reagent media 12a-12h exposed through cutouts 14a-14h in the layer 16, by grasping the ear 40 and pulling it forward as shown by the arrow in FIG. 4 until the layer 34 is fully withdrawn from the from the front of the device 10.

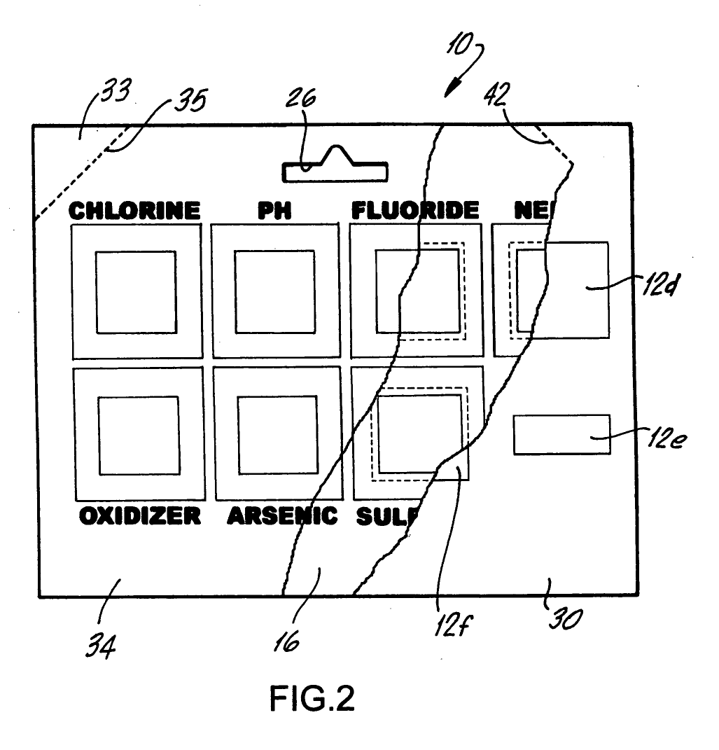

FIG. 2 is an elevational view of the detection device 10, with the clip 22 and strap 24 removed, and with the clear film layer 34 and the cover layer 16 each broken away to show further details of the device. The front surface of the support layer 30, a portion of which is exposed in FIG. 2, serves as a backing or substrate on which each of the eight reagent media 12a-12h is disposed so as to register with the corresponding cutouts 14a-14h in the cover layer 16 when the latter is placed on the support layer 30. The cover layer 16 preferably has a contact adhesive applied on its rear surface so as to bond firmly against the back layer with the reagent media 12a-12h securely sandwiched between the two layers 16, 30, and aligned symmetrically beneath the corresponding cutouts 14a-14h in the cover layer 16.

Typical overall dimensions for the device 10 are approximately 72 mm high by 87 mm wide as viewed in FIG. 1. Except for a specialty agent media such as the reagent media 12e for detecting cyanide, each of the reagent media measures typically about 15 mm by 15 mm square. The corresponding window cutouts 14a-14d and 14f-14h in the cover layer 16 typically measure about 12 mm by 12 mm square. The media 12e typically measures about 19 mm by 10 mm, and the corresponding cutout 14e in the cover layer typically measures about 16 mm by 8 mm. The cover layer 16 and the support layer 30 are preferably formed of coated paper that is weather resistant and can accept printing with, e.g., four color process inks to ensure a high level of color detail and sharpness of printed text. Examples of the reagent media 12a-12h are given below.

### Chlorine Reagent Media 12a

CHLORTESMO strips available from Macherey-Nagel, Gmbh. Limit of sensitivity 1 mg/liter chlorine.

### pH Reagent Media 12b

Litmus neutral paper available from Macherey-Nagel, Gmbh. Color changes above and below pH 7.0.

### Fluoride Reagent Media 12c

Fluoride test paper available from Macherey-Nagel, Gmbh. Limit of sensitivity 20 mg/liter fluoride.

### Nerve agent reagent media 12d

M-8 paper available from Anachemia-Canada.

### Cyanide Reagent Media 12e

“CYANTESMO”—available from Macherey-Nagel, Gmbh. Limit of sensitivity 0.2 mg/liter HCN.

### Sulfide reagent media 12f

Lead acetate paper, available from Macherey-Nagel, Gmbh. Limit of sensitivity 5 mg/liter sulphide.

### Arsenic Reagent Media 12g

Mercury Bromide/Arsenic Test Paper, available from available from Macherey-Nagel, Gmbh. Limit of sensitivity 0.5 μg arsenic or arsine.

### Oxidizer Reagent Media 12h

Potassium iodide starch paper, available from Macherey-Nagel, Gmbh. Limit of sensitivity 1 mg/liter free Cl₂/NO₂.

The present hazardous substance detection device 10 is considered to be an “article” under 29 C.F.R. § 1910.1200—OSHA Hazard Communication. An “article” is defined as being a manufactured item: (1) which is formed to be a specific shape or design during manufacture; (2) which has end use functions dependent in whole or in part upon its shape or design during end use; and (3) which does not release, or otherwise result in exposure to, a hazardous chemical under normal (intended) conditions of use.

Table 1, below, gives the normal or rest color and the reaction colors for each of the reagent media.

TABLE 1

| REAGENT | PAPER COLOR | POSITIVE INDICATION |
|---|---|---|
| (Target) | (Normal) | (Reaction with target) |
| Chlorine | Light Yellow | Blue/white spots |
| PH | Light Brown | Red/blue |
| Fluoride | Pink | Yellow white spots |
| Nerve | Brown | Gold, red, green |
| Oxidizers | White | Blue-violet spots |
| Arsenic | White | Yellow-brown |
| Hydrogen Sulfide | White | Brown/black |
| Cyanide | Pale Green | Blue |

Table 2, below, shows typical substance or agent levels at which the reagent media activate.

TABLE 2

| | |
|---|---|
| PH: | color changes above and below pH 7.0 |
| Chlorine: | limit of sensitivity 1 ppm chlorine; |
| | will also hit on bromine |
| Oxidizer: | 1 ppm |
| Cyanide: | 0.2 ppm HCN |
| Fluoride: | 20 ppm fluoride |
| Sulphide: | 0.5 ppm sulphide |
| Arsenic: | 0.5 ppb arsenic or arsine |
| Nerve-G: | 100 μ drops |
| Nerve-VX: | 100 μ drops |
| Mustard-H: | 100 μ drops |

Once the protective clear film layer 34 is removed, the device 10 is activated and will work effectively for 12 hours or more. Accordingly, the device meets a current need for a cost effective, reliable, and easy-to-use detection device that enables a number of different categories of users to detect many classes of hazardous substances quickly in the field, and to take appropriate action in the least amount of time. For example;

Police—Police officers are often needed to assist in evacuation and/or traffic control within an incident scene. Most organizations do not outfit police officers with any type of respiratory protection or chemical protective clothing for use during these activities. With the device 10, an officer would quickly know if he or she is within an area of potential harm and needs to decontaminate, or to remove himself/herself from the location.

Fire Departments—Hazardous materials teams are equipped to monitor toxic chemicals, but fire responders lack this ability due to the costs associated with the necessary equipment. The device 10 could be used by each riding position on a fire apparatus. In the event the crew encounters a potential hazardous environment, firefighters could place the device 10 on their sleeve. If firefighters are involved with rescuing victims, they will be able quickly to identify potential chemical agents that may be of harm by looking for contrasting color changes on the device, decontaminate, or remove themselves from the hazardous environment.

EMS—Many ambulance personnel are also not equipped to respond to chemical emergencies. Rescue crews are often dispatched to chemical exposures when responding to medical calls such as “difficulty breathing” or “man passed out”. If an ambulance crew suspects possible hazardous materials, they can quickly place the device 10 on their uniform, activate it, and withdraw safely in the event of a color change to request additional assistance from a Hazardous Materials Response Unit.

Hospital Emergency Rooms—Contaminated patients often enter emergency rooms without having been properly decontaminated. This puts the entire emergency room at risk for cross contamination and potential shutdown. The present device 10 can be used by the ER staff to ensure their safety by recognizing contamination early.

Hazardous Materials Teams and Waste Workers—The device 10 can be used by these personnel while wearing a fully encapsulated chemical protective ensemble, and to augment electronic monitoring. This would be an effective and inexpensive way for entry team personnel to identify quickly if they are in an area that has an unsafe concentration of product.

Military and Special Teams—Special teams such as SWAT, FBI, executive protection, and military do not have electronic monitoring devices available for each agent or soldier. The present device 10 can be issued to each team member, allowing for instant identification of unsafe substances or agents within a given area, and a need for decontamination or evacuation.

While the foregoing represents a preferred embodiment of the invention, it will be understood by those skilled in the art that various modifications and changes may be made without departing from the spirit and scope of the invention. For example, the color borders 18a-18h and text indicia 20a-20h may be applied directly on the support layer 30 adjacent the corresponding reagent media 12a-12h, and the cover layer 16 may be transparent. Accordingly, the invention includes all such modifications and changes as come within the scope of the following appended claims.

We claim:

1. A device for detecting the presence of hazardous substances in a user's environment, comprising:
a support layer having a major front surface and a major back surface;
a number of reagent media each of which is disposed at a corresponding location on the front surface of the support layer;
each one of the reagent media is operative to exhibit (i) a known rest color when in a non-reactive state, and (ii) a reaction color different from the rest color when the media reacts with a certain hazardous substance;
a cover layer disposed over the reagent media, wherein the cover layer is formed so that each of the reagent media is visible through the cover layer;
either the support layer or the cover layer has text indicia that is visible on or through the cover layer and is located so that the hazardous substance with which a given reagent media reacts is identified by the text indicia in proximity to the given reagent media; and
either the support layer or the cover layer has color indicia that is visible on or through the cover layer and which is placed so that (i) the rest color of a given reagent media is matched by the color indicia in proximity to the given reagent media, and (ii) when one or more of the reagent media react with hazardous substances, the reacting reagent media are identified by contrast of their reaction colors with the color indicia proximate to the reagent media.

2. A device according to claim 1, wherein the cover layer has a number of cutouts that are located and dimensioned to register with corresponding ones of the reagent media on the support layer.

3. A device according to claim 2, wherein the cover layer has said text indicia disposed adjacent to corresponding ones of the cutouts.

4. A device according to claim 2, wherein the cover layer has said color indicia disposed adjacent to corresponding ones of the cutouts.

5. A device according to claim 4, wherein the color indicia is formed to frame said cutouts.

6. A device according to claim 1, including a fastener fixed to a part of the device and arranged for attachment to a person's clothing or uniform.

7. A device according to claim 1, including an adhesive on a major rear surface of the support layer for securing the device to a person's clothing or uniform.

8. A device according to claim 7, including a removable sheet material provided over the adhesive on the rear surface of the support layer to prevent the adhesive from direct contact with outside surfaces.

9. A device according to claim 8, wherein a first ear is defined at a corner of the device, the first ear includes a corresponding corner of the sheet material, and the first ear is formed so that the sheet material is peeled away from said adhesive by urging the first ear backward and away from the device.

10. A device according to claim 1, including a removable, protective film layer adhered on the cover layer to maintain the reagent media in a fresh state.

11. A device according to claim 10, wherein a second ear is defined at a corner of the device, the second ear includes a corresponding corner of the film layer, and the second ear is formed so that the film layer is peeled away from the cover layer by urging the second ear forward and away from the device.

12. A device according to claim 1, wherein the reagent media are formulated to react with one or more hazardous classes of chlorine, pH, fluoride, nerve agents, cyanide, sulfides, arsenic and oxidizers.
